(19) United States
(12) Patent Application Publication
(10) Pub. No.: US 2025/0279022 A1
(43) Pub. Date: Sep. 4, 2025

(54) ELECTRONIC DEVICE AND IMAGE PROCESSING METHOD THEREOF

(71) Applicant: SAMSUNG ELECTRONICS CO., LTD., Suwon-si (KR)

(72) Inventors: Yoosun JUNG, Suwon-si (KR); Woonsung PARK, Suwon-si (KR); Wonseok SONG, Suwon-si (KR)

(73) Assignee: SAMSUNG ELECTRONICS CO., LTD., Suwon-si (KR)

(21) Appl. No.: 19/210,701

(22) Filed: May 16, 2025

Related U.S. Application Data
(63) Continuation of application No. PCT/KR2023/020053, filed on Dec. 7, 2023.

(30) Foreign Application Priority Data
Jan. 25, 2023 (KR) 10-2023-0009448

(51) Int. Cl. G09G 3/20; H04N 7/01

(52) U.S. Cl. CPC G09G 3/20; H04N 7/0135; G09G 2340/0435

(57) ABSTRACT

An electronic device includes a display, memory, and one or more processors. The electronic device, based on original frame rates of respective image areas of an input image being identified, identifies interpolation time points for the respective image areas and a plurality of key frames based on the original frame rates of the respective image areas, obtains interpolated frames corresponding to the interpolation time points for the respective image areas based on the plurality of key frames, and controls the display to display an output image based on the obtained interpolated frames.

### CROSS-REFERENCE TO RELATED APPLICATIONS

This application is a bypass continuation application of International Application No. PCT/KR2023/020053, filed on Dec. 7, 2023, which claims priority to Korean Patent Application No. 10-2023-0009448, filed on Jan. 25, 2023, in the Korean Intellectual Property Office, the disclosures of which are incorporated by reference herein in their entireties.

### BACKGROUND

### 1. Field

The present disclosure relates to an electronic device and an image processing method thereof, and more particularly, to an electronic device that performs frame interpolation and an image processing method thereof.

### 2. Description of Related Art

With the development of electronic technology, various types of electronic devices are being developed and distributed. In particular, display apparatuses such as televisions (TVs) and mobile devices are actively being developed and distributed.

For example, various frame interpolation methods that provide smooth motion are being studied in order to provide users with images with better quality.

### SUMMARY

According to an aspect of the disclosure, there is provided an electronic device including: a display; memory storing at least one instruction; and one or more processors operatively connected to the display and the memory, wherein the at least one instruction, when executed by the one or more processors individually or collectively, cause the electronic device to: based on original frame rates of respective image areas of an input image being identified, identify interpolation time points for the respective image areas and a plurality of key frames based on the original frame rates of the respective image areas; obtain interpolated frames corresponding to the interpolation time points for the respective image areas based on the plurality of key frames; and control the display to display an output image based on the obtained interpolated frames.

The at least one instruction, when executed by the one or more processors individually or collectively, may cause the electronic device to: based on a first original frame rate of a first image area of the input image being identified as a first frame rate and a second original frame rate of a second image area of the input image being identified as a second frame rate, identify a first interpolation time point of the first image area and a second interpolation time point of the second image area based on at least one of the first frame rate or the second frame rate; and obtain an interpolated frame in which the first image area and the second image area are interpolated based on the first interpolation time point of the first image area and the second interpolation time point of the second image area.

The at least one instruction, when executed by the one or more processors individually or collectively, may cause the electronic device to: identify the first interpolation time point of the first image area and a plurality of first key frames based on the first frame rate; identify the second interpolation time point of the second image area and a plurality of second key frames based on the second frame rate; obtain a first interpolated image corresponding to the first interpolation time point of the first image area based on the plurality of first key frames; obtain a second interpolated image corresponding to the second interpolation time point of the second image area based on the plurality of second key frames; and obtain the interpolated frame in which the first image area and the second image area are interpolated based on the first interpolated image and the second interpolated image.

The at least one instruction, when executed by the one or more processors individually or collectively, may cause the electronic device to: identify a plurality of common key frames based on one of the first frame rate or the second frame rate; identify the first interpolation time point of the first image area based on the plurality of common key frames and the first frame rate; identify the second interpolation time point of the second image area based on the plurality of common key frames and the second frame rate; obtain a first interpolated image corresponding to the first interpolation time point of the first image area and a second interpolated image corresponding to the second interpolation time point of the second image area based on the plurality of common key frames; and obtain the interpolated frame in which the first image area and the second image area are interpolated based on the first interpolated image and the second interpolated image.

One of the first frame rate or the second frame rate may be a relatively lower frame rate among the first frame rate and the second frame rate.

The at least one instruction, when executed by the one or more processors individually or collectively, may cause the electronic device to, based on the first frame rate being a frame lower than the second frame rate and the plurality of common key frames not including a key frame corresponding to at least one interpolation time point of the second image area, obtain interpolated frames corresponding to the at least one interpolation time point by adjusting the interpolation time points between a first input time point of a first command key frame and a second input time point of a second command key frame.

The at least one instruction, when executed by the one or more processors individually or collectively, may cause the electronic device to: identify and store an interpolation time point, an interpolation cycle and a key frame input time point according to a combination of original frame rates of the respective image areas in the memory; based on the original frame rates of the respective image areas of the input image being identified, identify the interpolation time point, the interpolation cycle, and the key frame input time point corresponding to the original frame rates of the respective image areas based on information stored in the memory; and obtain interpolated frames for the respective image areas based on the identified interpolation time point, the identified interpolation cycle, and the identified key frame input time.

The at least one instruction, when executed by the one or more processors individually or collectively, may cause the electronic device to: identify Sum of Absolute Difference (SAD) values for the respective image areas identified for consecutive frames of the input image; and identify the original frame rates of the respective image areas by identifying SAD patterns for the respective image areas according to a case in which a SAD value of a previous frame and a current frame is less than a threshold value and a case in which the SAD value is equal to or greater than the threshold value.

The at least one instruction, when executed by the one or more processors individually or collectively, may cause the electronic device to, based on the original frame rates of the respective image areas being identified based on the SAD patterns for the respective image areas, adjust the original frame rates of the respective image areas based on a difference in an original frame rate between a specific image area and adjacent image areas.

The at least one instruction, when executed by the one or more processors individually or collectively, may cause the electronic device to obtain an interpolated frame for conversion of a frame rate to be output between interpolated frames based on the obtained interpolated frame for respective image areas when frame rate conversion is required based on an output frequency of the display.

According to an aspect of the disclosure, there is provided a controlling method of an electronic device including: based on original frame rates of respective image areas of an input image being identified, identifying interpolation time points for the respective image areas and a plurality of key frames based on the original frame rates of the respective image areas; obtaining interpolated frames corresponding to the interpolation time points for the respective image areas based on the plurality of key frames; and displaying an output image based on the obtained interpolated frames.

The identifying interpolation time points for the respective image areas and the plurality of key frames may include, based on a first original frame rate of a first image area of the input image being identified as a first frame rate and a second original frame rate of a second image area of the input image being identified as a second frame rate, identifying a first interpolation time point of the first image area and a second interpolation time point of the second image area based on at least one of the first frame rate or the second frame rate; and wherein the obtaining an interpolated frame may include obtaining the interpolated frame in which the first image area and the second image area are interpolated based on the first interpolation time point of the first image area and the second interpolation time point of the second image area.

The identifying interpolation time points for the respective image areas and the plurality of key frames may include: identifying the first interpolation time point of the first image area and a plurality of first key frames based on the first frame rate; and identifying the second interpolation time point of the second image area and a plurality of second key frames based on the second frame rate; wherein the obtaining the interpolated frame may include: obtaining a first interpolated image corresponding to the first interpolation time point of the first image area based on the plurality of first key frames; obtaining a second interpolated image corresponding to the second interpolation time point of the second image area based on the plurality of second key frames; and obtaining the interpolated frame in which the first image area and the second image area are interpolated based on the first interpolated image and the second interpolated image.

The identifying interpolation time points for the respective image areas and the plurality of key frames may include: identifying a plurality of common key frames based on one of the first frame rate or the second frame rate; identifying the first interpolation time point of the first image area based on the plurality of common key frames and the first frame rate; and identifying the second interpolation time point of the second image area based on the plurality of common key frames and the second frame rate, wherein the obtaining an interpolated frame may include: obtaining a first interpolated image corresponding to the first interpolation time point of the first image area and a second interpolated image corresponding to the second interpolation time point of the second image area based on the plurality of common key frames; and obtaining the interpolated frame in which the first image area and the second image area are interpolated based on the first interpolated image and the second interpolated image.

According to an aspect of the disclosure, there is provided a non-transitory computer-readable recording medium storing a computer instruction that, when executed by a processor of an electronic device, causes the electronic device to: based on original frame rates of respective image areas of an input image being identified, identify interpolation time points for the respective image areas and a plurality of key frames based on the original frame rates of the respective image areas; obtain interpolated frames corresponding to the interpolation time points for the respective image areas based on the plurality of key frames; and display an output image based on the obtained interpolated frames.

### BRIEF DESCRIPTION OF THE DRAWINGS

The above and other aspects and/or features of one or more embodiments of the disclosure will be more apparent from the following detailed description, taken in conjunction with the accompanying drawings, in which:

FIG. 1 is a view provided to explain an implementation example of an electronic device according to an embodiment;

FIG. 2A is a block diagram illustrating configuration of an electronic device according to an embodiment;

FIG. 2B is a block diagram illustrating configuration of a display apparatus in detail according to an embodiment;

FIG. 3 is a flowchart provided to explain an image processing method of an electronic device according to an embodiment;

FIG. 4 is a flowchart provided to explain an image processing method of an electronic device according to an embodiment;

FIG. 5 is a view provided to explain the image processing method shown in FIG. 4 in detail;

FIG. 6 is a flowchart provided to explain an image processing method of an electronic device according to an embodiment;

FIG. 7 is a view provided to explain the image processing method shown in FIG. 6 in detail;

FIGS. 8, 9A, and 9B are views provided to explain a method of obtaining original frame rates of respective image areas according to an embodiment;

FIG. 10 is a view provided to explain patterns for respective areas based on an input point in time according to an embodiment;

FIG. 11 is a view provided to explain a method of identifying an interpolation time point and a key frame according to an embodiment;

FIG. 12 is a view provided to explain a method of identifying an interpolation time point and a key frame according to an embodiment; and

FIGS. 13 and 14 are views provided to explain a method of converting an output frame rate according to an embodiment.

### DETAILED DESCRIPTION

Hereinafter, embodiments of the present disclosure will be described in detail with reference to the accompanying drawings.

The terms used in the present disclosure will be briefly described before the present disclosure is described in detail.

General terms that are currently widely used are selected as the terms used in the embodiments of the disclosure in consideration of their functions in the disclosure, but may be changed based on the intention of those skilled in the art or a judicial precedent, the emergence of a new technique, or the like. In addition, in a specific case, terms arbitrarily chosen by an applicant may exist, in which case, the meanings of such terms will be described in detail in the corresponding descriptions of the disclosure. Thus, the terms used in the embodiments of the disclosure need to be defined on the basis of the meanings of the terms and the overall contents throughout the disclosure rather than simple names of the terms.

In the disclosure, the expressions “have”, “may have”, “include” or “may include” used herein indicate existence of corresponding features (e.g., elements such as numeric values, functions, operations, or components), but do not exclude presence of additional features.

Herein, expression “at least one of A or B” indicates “A”, “B”, or “both of A and B.” The expression “one of A or B” indicates “A” or “B.”

Expressions “first”, “second”, “1st,” “2nd,” or the like, used in the disclosure may indicate various components regardless of sequence and/or importance of the components, will be used only in order to distinguish one component from the other components, and do not limit the corresponding components.

When it is described that an element (e.g., a first element) is referred to as being “(operatively or communicatively) coupled with/to” or “connected to” another element (e.g., a second element), it should be understood that it may be directly coupled with/to or connected to the other element, or they may be coupled with/to or connected to each other through an intervening element (e.g., a third element).

Singular expressions include plural expressions unless the context clearly dictates otherwise. In this specification, terms such as “comprise” or “have” are intended to designate the presence of features, numbers, steps, operations, components, parts, or a combination thereof described in the specification, but are not intended to exclude in advance the possibility of the presence or addition of one or more of other features, numbers, steps, operations, components, parts, or a combination thereof.

In exemplary embodiments, a ‘module’ or a ‘˜er’ may perform at least one function or operation, and be implemented as hardware or software or be implemented as a combination of hardware and software. A plurality of ‘modules’ or a plurality of ‘˜er’ may be integrated into at least one module and be implemented as at least one processor (not shown) except for a ‘module’ or a ‘˜er’ that needs to be implemented as specific hardware.

Hereinafter, an embodiment of the present disclosure will be described in detail with reference to the accompanying drawings.

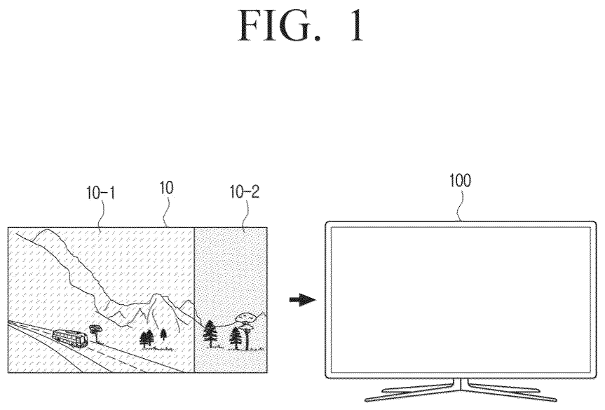

FIG. 1 is a view provided to explain an implementation example of an electronic device according to an embodiment.

The electronic device 100 may be implemented as a television or a set-top box as shown in FIG. 1, but is not limited thereto, and may be any device with image processing and/or display functions, such as, but not limited to, smartphone, tablet PC, notebook PC, head mounted display (HMD), near eye display (NED), large format display (LFD), digital signage, digital information display (DID), video wall, projector display, camera, camcorder, printer, etc.

The electronic device 100 may receive various compressed images or images of various resolutions. For example, the electronic device 100 may receive an image compressed in Moving Picture Experts Group (MPEG) (e.g., MP2, MP4, MP7, etc.), joint photographic coding experts group (JPEG), Advanced Video Coding (AVC), H.264, H.265, High Efficiency Video Codec (HEVC), etc. Alternatively, the electronic device 100 may receive an image in any one of standard definition (SD), high definition (HD), full HD, ultra HD, or an image with higher resolution.

According to an embodiment, the electronic device 100 may receive an image having a plurality of different original frame rates. Here, an image having a plurality of different original frame rates may refer to an image in which each of a plurality of areas within the image has a different original frame rate. For example, as shown in FIG. 1, in the case of a 60 Hz image of an input image 10, the original frame rate of a first area 10-1 may be 30 Hz, and the original frame rate of a second area 10-2 may be 24 Hz. In this case, when interpolating the entire image using an interpolation method corresponding to the original frame rate of the area to be prioritized, an image with smooth motion without motion judder is generated in a specific area, but there is a problem in that motion judder remains or worsens in other areas.

Accordingly, hereinafter, various embodiments are described for obtaining a smooth motion image without motion judder by identifying the original frame rate for each area of an image having multiple different original frame rates and performing motion estimation and motion interpolation according to the corresponding original frame rate for each area.

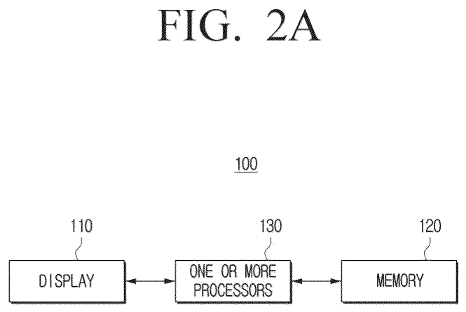

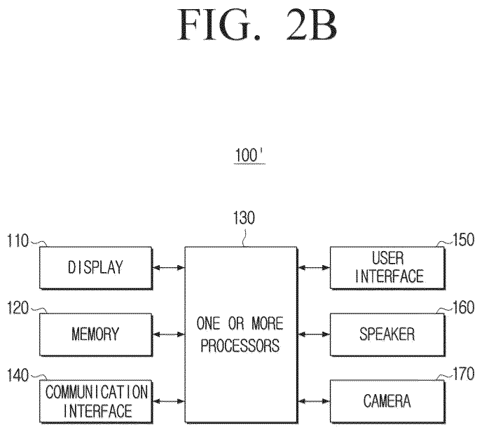

FIG. 2A is a block diagram illustrating configuration of an electronic device according to an embodiment.

According to FIG. 2A, the electronic device 100 includes a display 110, memory 120, and one or more processors 130.

The display 110 may be implemented as a display including a self-light emitting device or a display including a non-light emitting device and a backlight. For example, the display 110 may be implemented as various types of displays such as a liquid crystal display (LCD), an organic light emitting diode (OLED) display, a light emitting diodes (LEDs), a micro LED display, Mini LED display, a plasma display panel (PDP), a quantum dot (QD) display, a quantum dot light-emitting diode (QLED) display, and the like. The display 110 may also include a driving circuit, a backlight unit, and the like, which may be implemented in the form of amorphous silicon thin film transistor (a-si TFTs), low temperature poly silicon (LTPS) TFTs, organic TFTs (OTFTs), and the like. According to an embodiment, the display 110 may be implemented as a flat display, a curved display, a flexible display that can be folded or/and rolled, etc. However, in some cases, the electronic device 100 may not be equipped with the display 110, in which case the finally obtained output image may be transmitted to an external device equipped with a display.

The memory 120 may store data required for various embodiments of the present disclosure. The memory 120 may be implemented as a memory embedded in the electronic device 100 or as a memory detachable from the electronic device 100 depending on the data storage purpose. For example, in the case of data for driving the electronic device 100, the data may be stored in the memory embedded in the electronic device 100, and in the case of data for the expansion function of the electronic device 100, the data may be stored in the memory detachable from the electronic device 100. The memory embedded in the electronic device 100 may be implemented as at least one of a volatile memory (e.g., a dynamic RAM (DRAM), a static RAM (SRAM), or a synchronous dynamic RAM (SDRAM)), or a non-volatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a flash memory (e.g. a NAND flash or a NOR flash), a hard drive, or a solid state drive (SSD)). The memory detachable from the electronic device 100 may be implemented in the form of a memory card (e.g., a compact flash (CF), a secure digital (SD), a micro secure digital (Micro-SD), a mini secure digital (Mini-SD), an extreme digital (xD), or a multi-media card (MMC)), an external memory connectable to a USB port (e.g., a USB memory), or the like.

According to an embodiment, the memory 120 may store a plurality of contrast enhance curves. For example, the contrast enhancement curves may be implemented as tone mapping curves. Here, the tone mapping is a method of expressing the original tone of an image to match the dynamic range of the display 110, which may optimize contrast to provide optimized color.

The one or more processors 130 control the overall operations of the electronic device 100. Specifically, the one or more processors 130 may be connected to each configuration of the electronic device 100 to control the overall operations of the electronic device 100. For example, the one or more processors 130 may be operatively or electrically coupled to the display 110 and the memory 120 to control the overall operations of the electronic device 100. The one or more processors 130 may consist of one or a plurality of processors.

The one or more processors 130 may perform the operations of the electronic device 100 according to various embodiments by executing at least one instruction stored in the memory 120.

The one or more processors 130 may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The one or more processors 130 may control one or any combination of the other components of the electronic device, and may perform communication-related operations or data processing. The one or more processors 130 may individually or collectively execute at least one program or instruction stored in the memory. For example, the one or more processors may perform a method according to an embodiment by individually or collectively executing at least one instruction stored in the memory.

When a method according to an embodiment includes a plurality of operations, the plurality of operations may be performed by one processor or by a plurality of processors. For example, when a first operation, a second operation, and a third operation are performed by the method according to an embodiment, all of the first operation, the second operation, and the third operation may be performed by the first processor, or the first operation and the second operation may be performed by the first processor (e.g., a general-purpose processor) and the third operation may be performed by the second processor (e.g., an artificial intelligence-dedicated processor).

The one or more processors 130 may be implemented as a single core processor including a single core or as one or more multicore processors including a plurality of cores (e.g., homogeneous multicore or heterogeneous multicore). When the one or more processors 130 are implemented as a multicore processor, each of the plurality of cores included in the multicore processor may include internal memory of the processor such as cache memory and an on-chip memory, and a common cache shared by the plurality of cores may be included in the multicore processor. Each of the plurality of cores (or some of the plurality of cores) included in the multicore processor may independently read and perform program instructions to implement the method according to an embodiment, or all (or some) of the plurality of cores may be coupled to read and perform program instructions to implement the method according to an embodiment.

When a method according to an embodiment includes a plurality of operations, the plurality of operations may be performed by one core of a plurality of cores included in a multi-core processor, or may be performed by a plurality of cores. For example, when a first operation, a second operation, and a third operation are performed by a method according to an embodiment, all of the first operation, the second operation, and the third operation may be performed by the first core included in the multi-core processor, or the first operation and the second operation may be performed by the first core included in the multi-core processor and the third operation may be performed by the second core included in the multi-core processor.

In the embodiments of the present disclosure, the processor may mean a system-on-chip (SoC) in which one or more processors and other electronic components are integrated, a single-core processor, a multi-core processor, or a core included in a single-core processor or multi-core processor and here, the core may be implemented as CPU, GPU, APU, MIC, DSP, NPU, hardware accelerator, or machine learning accelerator, etc., but the core is not limited to the embodiments of the present disclosure. Hereinafter, the one or more processors 130 will be referred to as the processor 130 for convenience of explanation.

FIG. 2B is a block diagram illustrating configuration of a display apparatus in detail according to an embodiment.

Referring to FIG. 2B, an electronic device 100′ may include the display 110, the memory 120, the one or more processors 130, a communication interface 140, a user interface 150, a speaker 160, and a camera 170. Any configuration shown in FIG. 2B that is redundant of the configuration shown in FIG. 2A will be omitted from further description.

The communication interface 140 may support various communication methods depending on the implementation example of the electronic device 100′. For example, the communication interface 140 may perform communication with an external device, an external storage medium (e.g., USB memory), an external server (e.g., cloud server), or the like through communication methods such as Bluetooth, AP-based Wi-Fi (Wireless LAN Network), Zigbee, wired/wireless Local Area Network (LAN), Wide Area Network (WAN), Ethernet, IEEE 1394, High-Definition Multimedia Interface (HDMI), Universal Serial Bus (USB), Mobile High-Definition Link (MHL), Audio Engineering Society/European Broadcasting Union (AES/EBU), Optical, Coaxial, etc.

The user interface 150 may be implemented as a device such as a button, a touch pad, a mouse, and a keyboard, or may be implemented as a touch screen capable of performing the above-described display function and manipulation input function. According to an embodiment, the user interface 150 may be implemented as a remote control transmitting/receiving unit to receive a remote control signal. The remote control transmitting/receiving unit may receive a remote control signal from an external remote control device through at least one of infrared communication, Bluetooth communication or Wi-Fi communication, or transmit a remote control signal.

The speaker 160 outputs an acoustic signal. For example, the speaker 160 may convert a digital acoustic signal processed by the processor 130 to an analog acoustic signal, amplify it, and output it. For example, the speaker 160 may include at least one speaker unit, a D/A converter, an audio amplifier, or the like, capable of outputting at least one channel. According to an embodiment, the speaker 160 may be implemented to output a variety of multi-channel acoustic signals. In this case, the processor 130 may control the speaker 160 to enhance and output an input acoustic signal to correspond to the enhancement of the input image.

The camera 170 may be turned on and perform shooting according to a preset event. The camera 170 may convert a captured image into an electrical signal and generate image data based on the converted signal. For example, a subject may be converted into an electrical image signal through a semiconductor optical device (CCD; Charge Coupled Device), and the image signal converted in this way may be amplified and converted into a digital signal and then signal-processed.

The electronic device 100′ may include a microphone (not shown), a sensor (not shown), a tuner (not shown), and a demodulator (not shown), depending on the implementation example.

The microphone (not shown) is configured to receive a user voice or other sound and convert it into audio data. However, according to another embodiment, the electronic device 100′ may receive a user voice input through an external device via the communication interface 140.

The sensor (not shown) may include various types of sensors such as touch sensors, proximity sensors, acceleration sensors, geomagnetic sensors, gyro sensors, pressure sensors, position sensors, light sensors, and the like.

The tuner (not shown) may receive Radio Frequency (RF) broadcast signals by tuning to a channel selected by the user or all previously stored channels among RF broadcast signals received through an antenna.

The demodulator (not shown) may receive and demodulate a digital IF signal (DIF) converted from the tuner, and may also perform channel decoding, etc.

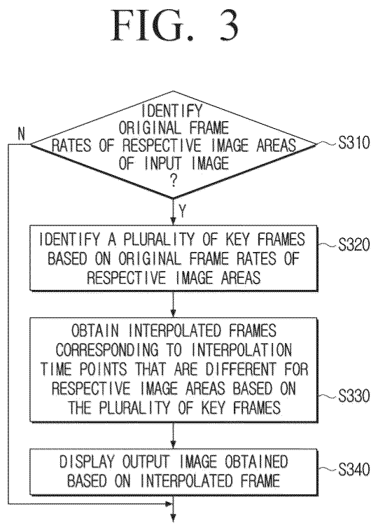

FIG. 3 is a flowchart provided to explain an image processing method of an electronic device according to an embodiment.

According to an embodiment shown in FIG. 3, once the original frame rates of respective image areas of the input image is identified (S310: Y), the processor 130 may identify a plurality of key frames based on the original frame rates of respective image areas (S320).

According to an embodiment, the processor 130 may identify consecutive first and second frames of the input image, and identify the original frame rate of the input image using a difference in pattern between the first and second frames. In this case, the input image may be identified as a plurality of areas, and the original frame rate may be identified for each of the plurality of areas. Here, the plurality of areas may each be a pixel group area of a preset size. For example, the preset size may be preset at the time of manufacturing of the electronic device 100, or may be set/changeable by the user. The size of the plurality of areas may not be fixed, and may change depending on the resolution, type, etc. of the input image.

According to an embodiment, the processor 130 may identify a Sum of Absolute Difference (SAD) value for respective image areas identified for consecutive frames of the input image in order to identify the original frame rates of respective image areas. In this case, the processor 130 may identify the original frame rates of respective image areas by identifying the SAD pattern for respective image areas according to the case where the SAD value of the previous frame and the current frame is below a threshold value and above a threshold value.

According to an embodiment, once the original frame rates of respective image areas is identified based on the SAD value pattern for each area, the processor 130 may correct the original frame rates of respective image areas based on a difference in the original frame rate between a specific image area and adjacent image areas. In this case, the processor 130 may identify the corrected original frame rate for each image as the final original frame rate.

Subsequently, the processor 130 may obtain interpolated frames corresponding to interpolation time points which are different for respective image areas based on the plurality of key frames (S330).

Here, the key frames are used to set parameters that change over time for a motion attribute, and the values between key frames may be interpolated by interpolated frames. When using keyframes to create changes over time, two or more key frames are used, one of which may represent the state at the start of a change and the other may represent the new state at the end of the change.

According to an embodiment, the processor 130 may identify an interpolation time point for each image, and obtain interpolated frames by interpolating respective image areas according to the identified interpolation time points. For example, the processor 130 may perform motion estimation by identifying motion information, i.e., a motion vector in units of the identified key frames. According to an embodiment, the processor 130 may perform motion estimation using a block matching algorithm, but is not necessarily limited thereto. For example, the processor 130 may divide an image frame into small blocks and predict a block to which the current block has moved in time to identify a motion vector corresponding to each block. According to an embodiment, the processor 130 may identify a motion vector using forward move estimation, which estimates motion of a reference block by searching a search area in a subsequent key frame based on the reference block identified in a previous key frame. However, in some cases, it is possible to use backward move estimation.

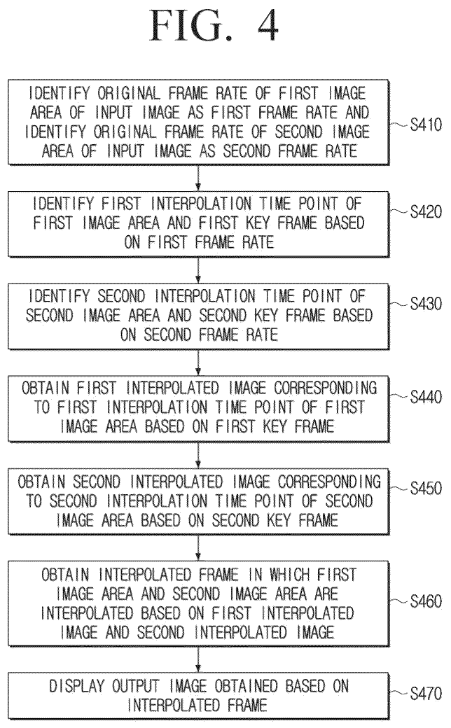

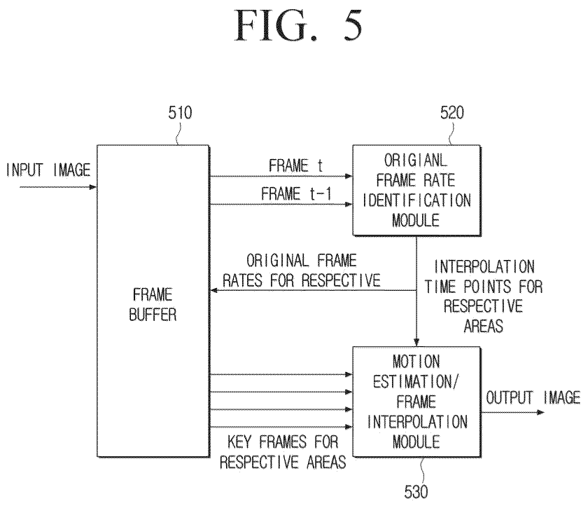

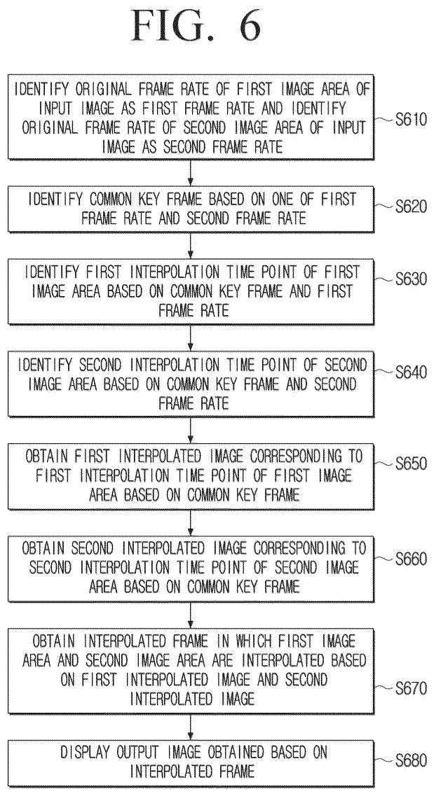

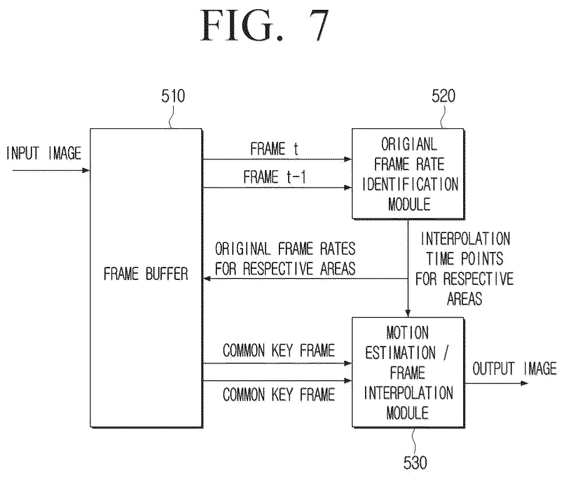

In this case, the processor 130 may identify the motion vector using a plurality of separate key frames for the original frame rates of respective image areas, or may identify the motion vector using a plurality of common key frames corresponding to any one of the original frame rates of respective image areas. The former will be described in greater detail with reference to FIGS. 4 and 5, and the latter will be described in greater detail with reference to FIGS. 6 and 7.

According to an embodiment, when the original frame rate of the first image area of the input image is identified as a first frame rate and the original frame rate of the second image area is identified as a second frame rate, the processor 130 may identify a first interpolation time point of the first image area and a second interpolation time point of the second image area based on at least one of the first frame rate or the second frame rate. Subsequently, the processor 130 may obtain an interpolated frame in which the first image area and the second image area are interpolated based on the first interpolation time point of the first image area and the second interpolation time point of the second image area.

According to an embodiment, the processor 130 may obtain interpolated frames corresponding to interpolation time points using a plurality of key frames and a motion vector. For example, when the motion vector is identified using a plurality of separate key frames for the original frame rates of respective image areas, the processor 130 may generate interpolated frames using the plurality of separate key frames for respective image areas.

Alternatively, when the motion vector is identified using a plurality of common key frames corresponding to any one of the original frame rates of respective image areas, the plurality of common key frames may be used to generate interpolated frames according to interpolation time points that are different for respective image areas.

Subsequently, the processor 130 may control the display 110 to display an output image obtained based on the interpolated frame.

FIG. 4 is a flowchart provided to explain an image processing method of an electronic device according to an embodiment.

According to one embodiment shown in FIG. 4, the processor 130 may identify the original frame rate of the first image area of the input image as a first frame rate and the original frame rate of the second image area as a second frame rate (S410).

Subsequently, the processor 130 may identify the first interpolation time point and the first key frame of the first image area based on the first frame rate (S420).

The processor 130 may identify the second interpolation time point and the second key frame of the second image area based on the second frame rate (S430).

Next, the processor 130 may obtain a first interpolated image corresponding to the first interpolation time point of the first image area based on the first key frame (S440).

The processor 130 may obtain a second interpolated image corresponding to the second interpolation time point of the second image area based on the second key frame (S450).

Subsequently, the processor 130 may obtain an interpolated frame in which the first image area and the second image area are interpolated based on the first interpolated image and the second interpolated image (S460).

The processor 130 may then display the output image obtained based on the interpolated frame through the display 110 (S470).

In FIG. 4, the order of all steps is mapped for convenience of explanation, but it is not necessarily limited thereto when the order is not relevant or the steps can be performed in parallel.

FIG. 5 is a view provided to explain the image processing method shown in FIG. 4 in detail.

Each function module shown in FIG. 5 may consist of a combination of at least one piece of hardware and/or at least one piece of software.

Referring to the drawing shown in FIG. 5, when an input image is received, the processor 130 may store the received input image in a frame buffer 510. For example, the frame buffer 510 may be implemented as an example of the memory 120.

Subsequently, the processor 130 may obtain the t-1st frame (or previous frame) and the t-th frame (current frame) from the frame buffer 510, and identify the original frame rates of respective image areas using an original frame identification module 520. According to an embodiment, the original frame rates of respective image areas identified through the original frame identification module 520 may be stored in the frame buffer 510, or may be stored in an area of the memory 120. For example, as described in FIG. 4, the original frame rate of the first image area of the input image may be identified as the first frame rate, and the original frame rate of the second image area may be identified as the second frame rate.

Next, the processor 130 may identify an interpolation time point for each area and a key frame for each area among the frames stored in the frame buffer 510. Here, the interpolation time point and key frame for each area may be identified based on the original frame rate for each area. For example, as described in FIG. 4, the interpolation time point of the first image area may be identified as the first interpolation time point, and the interpolation time point of the second image area may be identified as the second interpolation time point. The key frame of the first image area may be identified as the first key frame, and the key frame of the second image area may be identified as the second key frame. Here, the first key frame and the second key frame at each interpolation time point are individually identified, so they may be different or the same.

The processor 130 may then obtain interpolated images corresponding to interpolation time points for respective image areas using a motion estimation/frame interpolation module 530. According to an embodiment, the processor 130 may estimate motion information corresponding to each interpolation time point using a plurality of key frames corresponding to interpolation time points for respective image areas, and obtain interpolated images based on the estimated motion information. For example, as shown in FIG. 4, the first interpolated image corresponding to the first interpolation time point of the first image area and the second interpolated image corresponding to the second interpolation time point of the second image area may be obtained.

Subsequently, the processor 130 may use the motion estimation/frame interpolation module 530 to obtain interpolated frames based on the interpolated images corresponding to the interpolation time points for respective areas, and obtain an output image based on the input frames and the interpolated frames. For example, as described in FIG. 4, an interpolated frame in which the first image area and the second image area are interpolated may be obtained based on the first interpolated image and the second interpolated image.

FIG. 6 is a flowchart provided to explain an image processing method of an electronic device according to an embodiment.

According to one embodiment shown in FIG. 6, the processor 130 may identify the original frame rate of the first image area of the input image as the first frame rate and the original frame rate of the second image area of the input image as the second frame rate (S610).

Subsequently, the processor 130 may identify a common key frame based on any one of the first frame rate or the second frame rate. Here, the common key frame may be identified based on a relatively lower frame rate among the first frame rate and the second frame rate

The processor 130 may then identify the first interpolation time point of the first image area based on the common key frame and the first frame rate (S630).

The processor 130 may identify the second interpolation time point of the second image area based on the common key frame and the second frame rate (S640).

According to an embodiment, when the first frame rate is a lower frame rate than the second frame rate and the common key frame does not include a key frame corresponding to at least one interpolation time point of the second image area, the processor 130 may adjust the interpolation time point between the first input point of the first common key frame and the second input point of the second common key frame.

Subsequently, the processor 130 may obtain the first interpolated image corresponding to the first interpolation time point of the first image area based on the common key frame (S650).

The processor 130 may obtain the second interpolated image corresponding to the second interpolation time point of the second image area based on the common key frame (S660).

Next, the processor 130 may obtain an interpolated frame in which the first image area and the second image area are interpolated based on the first interpolated image and the second interpolated image (S670).

The processor 130 may then display an output image obtained based on the interpolated frame through the display 110 (S680).

In FIG. 6, the order of all steps is mapped for convenience of explanation, but it is not necessarily limited thereto when the order is not relevant or the steps can be performed in parallel.

FIG. 7 is a view provided to explain the image processing method shown in FIG. 6 in detail.

Each function module shown in FIG. 7 may consist of a combination of at least one piece of hardware and/or at least one piece of software.

Referring to the drawing shown in FIG. 7, when an input image is received, the processor 130 may store the received input image in the frame buffer 510.

Subsequently, the processor 130 may obtain the t-1st frame (or previous frame) and the t-th frame (current frame) from the frame buffer 510, and identify the original frame rates of respective image areas using the original frame identification module 520. According to an embodiment, the original frame rates of respective image areas identified through the original frame identification module 520 may be stored in the frame buffer 510, or may be stored in an area of the memory 120. For example, as described in FIG. 6, the original frame rate of the first image area of the input image may be identified as the first frame rate, and the original frame rate of the second image area may be identified as the second frame rate.

Next, the processor 130 may identify an interpolation time point for each area and a common key frame among the frames stored in the frame buffer 510. Here, the interpolation time point for each area and the key frame may be identified based on the original frame rate for each area. For example, as described in FIG. 6, the first interpolation time point of the first image area may be identified based on the common key frame and the first frame rate, and the second interpolation time point of the second image area may be identified based on the common key frame and the second frame rate.

The processor 130 may then then obtain interpolated images corresponding to interpolation time points for respective image areas using the motion estimation/frame interpolation module 530. According to an embodiment, the processor 130 may estimate motion information corresponding to each interpolation time point using a plurality of key frames corresponding to interpolation time points for respective image areas, and obtain interpolated images based on the estimated motion information. For example, as shown in FIG. 4, the first interpolated image corresponding to the first interpolation time point of the first image area and the second interpolated image corresponding to the second interpolation time point of the second image area may be obtained.

Subsequently, the processor 130 may use the motion estimation/frame interpolation module 530 to obtain interpolated frames based on the interpolated images corresponding to the interpolation time points for respective areas, and obtain an output image based on the input frames and the interpolated frames. For example, as described in FIG. 4, an interpolated frame in which the first image area and the second image area are interpolated may be obtained based on the first interpolated image and the second interpolated image.

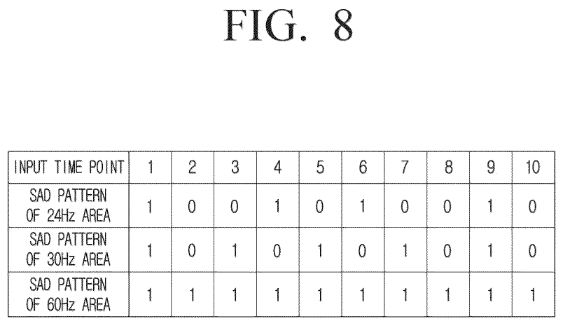

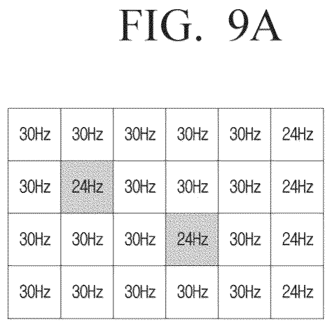

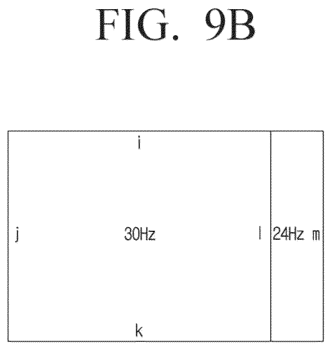

FIGS. 8, 9A, and 9B are views provided to explain a method of obtaining original frame rates of respective image areas according to an embodiment.

According to an embodiment, the processor 130 may identify a Sum of Absolute Difference (SAD) values for respective unit areas identified for consecutive frames of the input image in order to identify the original frame rates of respective image areas. For example, as shown in FIG. 8, when the SAD value of the previous frame and the current frame is below a threshold value, the processor 130 may map an indicator “0” and when the SAD value is above the threshold value, the processor 130 may map an indicator “1”, thereby identifying the SAD patterns for respective image areas to identify the original frame rates of respective unit areas. For example, when the input image is a 60 Hz image, the original 24 Hz image converted to 60 Hz via a 3:2 pulldown will have a pattern of 10010, and the original 30 Hz image converted to 60 Hz via a 2:2 pulldown will have a pattern of 1010. Accordingly, when a specific area within one image frame has the original frame rate of 30 Hz and another area has 24 Hz, the image frame will have a pattern as shown in FIG. 8.

According to an embodiment, when the original frame rates of respective unit areas are identified based on the SAD value patterns for respective unit areas, the processor 130 may correct the original frame rates of respective unit areas based on a difference in the original frame rate between a specific unit area and adjacent unit areas. In this case, the processor 130 may identify the corrected original frame rates of respective unit areas as the final original frame rates. In other words, the processor 130 may filter the identified original frame rates identified for respective unit areas to remove false detections of the unit areas. For example, when the original frame rates of respective unit areas are identified as shown in FIG. 9A, the filtering may remove the 24 Hz identification result of the unit areas indicated in gray. In other words, the original frame rate of the corresponding area may be corrected from 24 Hz to 30 Hz.

When the original frame rates of respective unit areas are finally identified, the identified final original frame rates may be used in the form of a map as shown in FIG. 9A or in the form of coordinates as shown in FIG. 9B, which includes information about the original frame rates of respective unit areas. For example, when the original frame rates of respective unit areas are identified in the original frame rate identification module 520, they may be transmitted to the motion estimation/frame interpolation module 530 as information in the form of a map or coordinates.

For example, in FIG. 9B, an area having the original frame rate of 30 Hz may be identified by the up/down/left/right coordinates of i,j,k,l, and an area having the original frame rate of 24 Hz may be identified by the up/down/left/right coordinates of i,l,k,m. Here, the coordinates are described using the identifiers i, l, k, l, m for convenience of explanation, and the form of the coordinates is not limited thereto.

According to an embodiment, when identifying SAD patterns for respective unit areas, the processor 130 may apply filtering that overlaps a window of a preset size (e.g., a block grid window). In this case, it is possible to reduce false detections in the unit areas more easily.

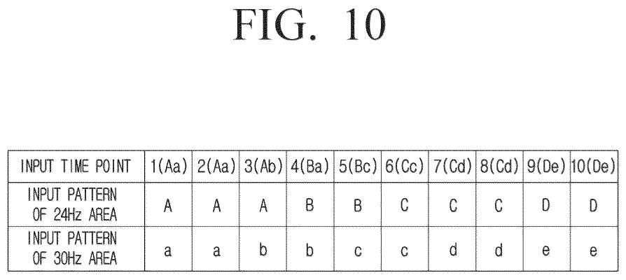

FIG. 10 is a view provided to explain patterns for respective areas based on an input point in time according to an embodiment.

According to an embodiment, when the original 24 Hz area converted to 60 Hz via a 3:2 pulldown and the original 30 Hz area converted to 60 Hz via a 2:2 pulldown are included in one image frame as shown in FIG. 10, frames in the form shown in FIG. 10 may be input at each time point. For example, at time point 1, a frame in which the original 24 Hz area includes image A and the original 30 Hz area includes image a may be input, and at time point 7, a frame in which the original 24 Hz area includes image C and the original 30 Hz area includes image d may be input.

In this case, the processor 130 may perform motion interpolation by identifying key frames corresponding to the original 24 Hz area and the original 30 Hz area. For example, motion estimation and frame interpolation may be performed by identifying key frames with reference to 24 Hz for the original 24 Hz area and motion estimation and frame interpolation may be performed by identifying key frames with reference to 30 Hz for the original 30 Hz area. For example, at time point 7, the processor 130 may perform motion estimation and frame interpolation using key frames C and D for the original 24 Hz area and key frames c and d for the original 30 Hz area.

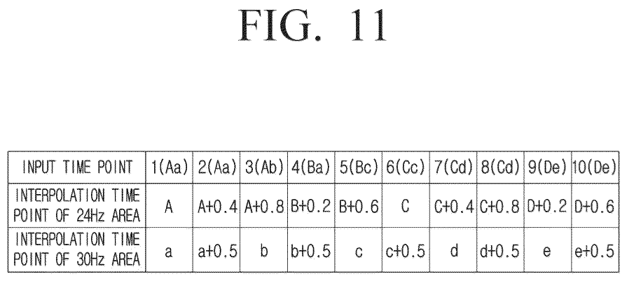

FIG. 11 is a view provided to explain a method of identifying an interpolation time point and a key frame according to an embodiment.

According to an embodiment, the processor 130 may perform motion estimation and frame interpolation by selecting separate key frames for respective image areas with different original frame rates.

According to an embodiment, as shown in FIG. 11, frame interpolation time points may be determined for respective image areas with different original frame rates.

For example, in the case of the original 24 Hz area, interpolation time points such as A, A+0.4, A+0.8, B+0.2 . . . may be identified. Here, time point A+0.4 can mean a time point between A and B, which is 40% away from A and 60% away from B. In other words, based on the A and B images, a motion vector corresponding to an interpolation time point that is 40% forward from image A and 60% backward from image B may be estimated to generate an interpolated frame corresponding to the interpolation time point.

In this case, although an input frame consisting of C and c and an input frame consisting of D and d are required for frame interpolation at time point 7, according to FIG. 10, an input frame consisting of D and d does not exist due to the difference in original frames for respective areas. Accordingly, the processor 130 may perform motion estimation and frame interpolation using input frames at different time points for respective areas as key frames.

However, in this case, the processor 130 has no choice but to store and use three or more key frames instead of two. Accordingly, the amount of frame memory required for the motion prediction and frame interpolation process may increase.

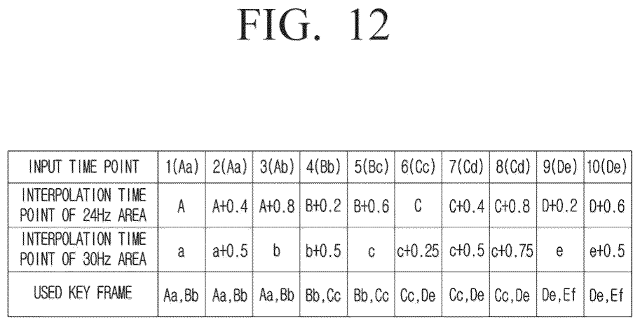

FIG. 12 is a view provided to explain a method of identifying an interpolation time point and a key frame according to an embodiment.

According to an embodiment, the processor 130 may perform motion estimation and frame interpolation by selecting common key frames for image areas that have different original frame rates. In other words, motion estimation and frame interpolation may be performed using common key frames for respective areas in order to avoid an increase in frame memory usage that may occur when separate key frames are used for respective areas as shown in FIG. 11.

According to an embodiment, the processor 130 may perform motion estimation and frame interpolation by identifying key frames based on an area with relatively low original frame rates among a plurality of image areas with different original frame rates. In this case, the processor 130 may set frame interpolation time points different for respective areas. For example, the processor 130 may calculate the interpolation time points of areas with relatively high original frame rates as time points with smooth motion with reference to key frames extracted based on areas with low original frame rates.

For example, it is assumed that there is a case where the input image has a frame rate of 60 Hz and one area is a 3:2 pulldown image with an original frame rate of 24 Hz and the remaining area is a 2:2 pulldown image with an original frame rate of 30 Hz. In this case, as shown in FIG. 12, the processor 130 may identify 1 time point frame A+a, 4 time point frame B+b, 6 time point frame C+c, and 9 time point frame D+e as common key frames based on the original 24 Hz area.

However, since there is no key frame to obtain frame d information in the original 30 Hz area, 6 time point frame C+c and 9 time point frame D+e may be used as key frames. In this case, since the interval between key frames is 2 frames based on the original frame, the interpolation interval may be reduced by half to generate interpolated frames at time point c+0.25, c+0.5, and c+0.75. In other words, interpolated frames corresponding to a time point between c and e, which is 25% apart from c and 75% apart from e, and a time point between c and e, which is 50% apart from c and e, and a time point between c and e, which is 75% apart from c and 25% apart from e may be generated

According to the interpolation time point pattern shown in FIG. 12, 10 frames, which are a common multiple of the 3:2 pulldown cycle and the 2:2 pulldown cycle, may be the interpolation cycle. Accordingly, the same interpolation time point may be repeated with a cycle of 10 frames.

As such, the interpolation time point may have a cycle determined based on the original frame rates of respective areas, so the interpolation time points and the interpolation cycles corresponding to the interpolation time points for each combination of the original frame rates for respective areas may be calculated in advance, and stored and used in the form of a lookup table.

According to an embodiment, the interpolation cycles according to the combination of various original frame rates such as a 60 Hz image including an original 24 Hz area and an original 30 Hz area, an original 30 Hz area, and a 120 Hz image including an original 60 Hz area, the interpolation time points corresponding to the interpolation cycles, and the interpolation cycles corresponding to the interpolation time points may be calculated in advance and stored in the form of a lookup table.

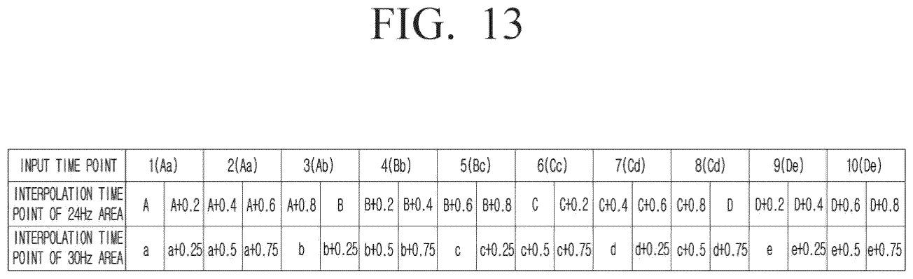

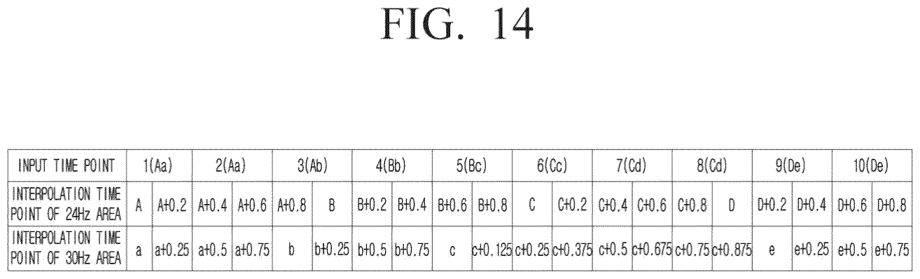

FIGS. 13 and 14 are views provided to explain a method of converting an output frame rate according to an embodiment.

According to an embodiment, when frame rate conversion is required based on the output frequency of the display 110, the processor 130 may obtain interpolated frames for frame rate conversion to be output between the interpolated frames based on the obtained interpolated frames for respective image areas.

According to an embodiment, when the input image is 60 Hz and the output image is 120 Hz, the image having the interpolation pattern shown in FIG. 11 may be interpolated for frame rate conversion as shown in FIG. 13. The image having the interpolation pattern shown in FIG. 11 may be interpolated for frame rate conversion as shown in FIG. 14. In other words, interpolated frames for frame rate conversion may be generated at a ½ time point between frame interpolation time points. For example, in FIG. 14, interpolated frames at time points c+0.25, c+0.5, and c+0.75 are generated at time points 6 to 8, respectively and thus, the interval between each interpolation time point is reduced by ½, and interpolated frames at c+0.125, c+0.375, c+0.5, c+0.675, c+0.75, and c+0.875 may be generated.

According to various embodiments described above, when the input image has different original frame rates for respective areas, motion estimation and motion interpolation may be performed according to the corresponding original frame rates for respective areas to obtain a smooth motion image without motion judder.

The methods according to various embodiments of the present disclosure described above may be implemented in the form of an application that can be installed on an existing display device. Alternatively, the methods according to various embodiments of the present disclosure described above may be performed using a deep learning-based artificial neural network (or deep artificial neural network), that is, a learning network model. According to an embodiment, interpolation frame generation may be performed using a learned neural network model.

The methods according to various embodiments of the present disclosure described above may be implemented by software upgrade to the existing display apparatuses, or by hardware upgrade alone.

The various embodiments of the disclosure described above may also be performed through an embedded server provided in the display apparatus or an external server of the display apparatus.

According to an embodiment, the above-described various embodiments may be implemented as software including instructions stored in machine-readable storage media, which can be read by machine (e.g.: computer). The machine refers to a device that calls instructions stored in a storage medium, and can operate according to the called instructions, and the device may include a display apparatus (e.g.; display apparatus (A)) according to the aforementioned embodiments. In case an instruction is executed by a processor, the processor may perform a function corresponding to the instruction by itself, or by using other components under its control. An instruction may include a code that is generated or executed by a compiler or an interpreter. The machine-readable storage medium may be provided in a form of a non-transitory storage medium. Here, the term “non-transitory” means that the storage medium is tangible without including a signal, and does not distinguish whether data are semi-permanently or temporarily stored in the storage medium.

According to an embodiment, the above-described methods according to the various embodiments may be included and provided in a computer program product. The computer program product may be traded as a product between a seller and a purchaser. The computer program product may be distributed in a form of a storage medium (for example, a compact disc read only memory (CD-ROM)) that may be read by the machine or online through an application store (for example, PlayStore™). In case of the online distribution, at least a portion of the computer program product may be at least temporarily stored in a storage medium such as a memory of a server of a manufacturer, a server of an application store, or a relay server or be temporarily generated.

The components (for example, modules or programs) according to various embodiments described above may include a single entity or a plurality of entities, and some of the corresponding sub-components described above may be omitted or other sub-components may be further included in the various embodiments. Alternatively or additionally, some components (e.g., modules or programs) may be integrated into one entity and perform the same or similar functions performed by each corresponding component prior to integration. Operations performed by the modules, the programs, or the other components according to the diverse embodiments may be executed in a sequential manner, a parallel manner, an iterative manner, or a heuristic manner, or at least some of the operations may be performed in a different order or be omitted, or other operations may be added.

Although embodiments of the present disclosure have been shown and described above, the disclosure is not limited to the specific embodiments described above, and various modifications may be made by one of ordinary skill in the art without departing from the spirit of the disclosure as claimed in the claims, and such modifications are not to be understood in isolation from the technical ideas or prospect of the disclosure.

What is claimed is:

1. An electronic device comprising:
a display;
memory storing at least one instruction; and
one or more processors operatively connected to the display and the memory,
wherein the at least one instruction, when executed by the one or more processors individually or collectively, causes the electronic device to:
based on original frame rates of respective image areas of an input image being identified, identify interpolation time points for the respective image areas and a plurality of key frames based on the original frame rates of the respective image areas;
obtain interpolated frames corresponding to the interpolation time points for the respective image areas based on the plurality of key frames; and
control the display to display an output image based on the obtained interpolated frames.

2. The electronic device as claimed in claim 1, wherein the at least one instruction, when executed by the one or more processors individually or collectively, causes the electronic device to:
based on a first original frame rate of a first image area of the input image being identified as a first frame rate and a second original frame rate of a second image area of the input image being identified as a second frame rate, identify a first interpolation time point of the first image area and a second interpolation time point of the second image area based on at least one of the first frame rate or the second frame rate; and
obtain an interpolated frame in which the first image area and the second image area are interpolated based on the first interpolation time point of the first image area and the second interpolation time point of the second image area.

3. The electronic device as claimed in claim 2, wherein the at least one instruction, when executed by the one or more processors individually or collectively, causes the electronic device to:
identify the first interpolation time point of the first image area and a plurality of first key frames based on the first frame rate;
identify the second interpolation time point of the second image area and a plurality of second key frames based on the second frame rate;
obtain a first interpolated image corresponding to the first interpolation time point of the first image area based on the plurality of first key frames;
obtain a second interpolated image corresponding to the second interpolation time point of the second image area based on the plurality of second key frames; and
obtain the interpolated frame in which the first image area and the second image area are interpolated based on the first interpolated image and the second interpolated image.

4. The electronic device as claimed in claim 2, wherein the at least one instruction, when executed by the one or more processors individually or collectively, causes the electronic device to:
identify a plurality of common key frames based on one of the first frame rate or the second frame rate;
identify the first interpolation time point of the first image area based on the plurality of common key frames and the first frame rate;
identify the second interpolation time point of the second image area based on the plurality of common key frames and the second frame rate;
obtain a first interpolated image corresponding to the first interpolation time point of the first image area and a second interpolated image corresponding to the second interpolation time point of the second image area based on the plurality of common key frames; and
obtain the interpolated frame in which the first image area and the second image area are interpolated based on the first interpolated image and the second interpolated image.

5. The electronic device as claimed in claim 4, wherein one of the first frame rate or the second frame rate is a relatively lower frame rate among the first frame rate and the second frame rate.

6. The electronic device as claimed in claim 5, wherein the at least one instruction, when executed by the one or more processors individually or collectively, causes the electronic device to, based on the first frame rate being a frame lower than the second frame rate and the plurality of common key frames not including a key frame corresponding to at least one interpolation time point of the second image area, obtain interpolated frames corresponding to the at least one interpolation time point by adjusting the interpolation time points between a first input time point of a first command key frame and a second input time point of a second command key frame.

7. The electronic device as claimed in claim 6, wherein the at least one instruction, when executed by the one or more processors individually or collectively, causes the electronic device to:
identify and store an interpolation time point, an interpolation cycle and a key frame input time point according to a combination of original frame rates of the respective image areas in the memory;
based on the original frame rates of the respective image areas of the input image being identified, identify the interpolation time point, the interpolation cycle, and the key frame input time point corresponding to the original frame rates of the respective image areas based on information stored in the memory; and
obtain interpolated frames for the respective image areas based on the identified interpolation time point, the identified interpolation cycle, and the identified key frame input time.

8. The electronic device as claimed in claim 1, wherein the at least one instruction, when executed by the one or more processors individually or collectively, causes the electronic device to:
identify Sum of Absolute Difference (SAD) values for the respective image areas identified for consecutive frames of the input image; and
identify the original frame rates of the respective image areas by identifying SAD patterns for the respective image areas according to a case in which a SAD value of a previous frame and a current frame is less than a threshold value and a case in which the SAD value is equal to or greater than the threshold value.

9. The electronic device as claimed in claim 8, wherein the at least one instruction, when executed by the one or more processors individually or collectively, causes the electronic device to, based on the original frame rates of the respective image areas being identified based on the SAD patterns for the respective image areas, adjust the original frame rates of the respective image areas based on a difference in an original frame rate between a specific image area and adjacent image areas.

10. The electronic device as claimed in claim 1, wherein the at least one instruction, when executed by the one or more processors individually or collectively, causes the electronic device to obtain an interpolated frame for conversion of a frame rate to be output between interpolated frames based on the obtained interpolated frame for respective image areas when frame rate conversion is required based on an output frequency of the display.

11. A controlling method of an electronic device, the controlling method comprising:
based on original frame rates of respective image areas of an input image being identified, identifying interpolation time points for the respective image areas and a plurality of key frames based on the original frame rates of the respective image areas;
obtaining interpolated frames corresponding to the interpolation time points for the respective image areas based on the plurality of key frames; and
displaying an output image based on the obtained interpolated frames.

12. The controlling method as claimed in claim 11, wherein the identifying interpolation time points for the respective image areas and the plurality of key frames comprises, based on a first original frame rate of a first image area of the input image being identified as a first frame rate and a second original frame rate of a second image area of the input image being identified as a second frame rate, identifying a first interpolation time point of the first image area and a second interpolation time point of the second image area based on at least one of the first frame rate or the second frame rate; and
wherein the obtaining an interpolated frame comprises obtaining the interpolated frame in which the first image area and the second image area are interpolated based on the first interpolation time point of the first image area and the second interpolation time point of the second image area.

13. The controlling method as claimed in claim 12, wherein the identifying interpolation time points for the respective image areas and the plurality of key frames comprises:
identifying the first interpolation time point of the first image area and a plurality of first key frames based on the first frame rate; and
identifying the second interpolation time point of the second image area and a plurality of second key frames based on the second frame rate;
wherein the obtaining the interpolated frame comprises:
obtaining a first interpolated image corresponding to the first interpolation time point of the first image area based on the plurality of first key frames;
obtaining a second interpolated image corresponding to the second interpolation time point of the second image area based on the plurality of second key frames; and
obtaining the interpolated frame in which the first image area and the second image area are interpolated based on the first interpolated image and the second interpolated image.

14. The controlling method as claimed in claim 12, wherein the identifying interpolation time points for the respective image areas and the plurality of key frames comprises:
identifying a plurality of common key frames based on one of the first frame rate or the second frame rate;
identifying the first interpolation time point of the first image area based on the plurality of common key frames and the first frame rate; and
identifying the second interpolation time point of the second image area based on the plurality of common key frames and the second frame rate,
wherein the obtaining the interpolated frame comprises:
obtaining a first interpolated image corresponding to the first interpolation time point of the first image area and a second interpolated image corresponding to the second interpolation time point of the second image area based on the plurality of common key frames; and
obtaining the interpolated frame in which the first image area and the second image area are interpolated based on the first interpolated image and the second interpolated image.

15. The controlling method as claimed in claim 12, wherein one of the first frame rate or the second frame rate is a relatively lower frame rate among the first frame rate and the second frame rate.

16. The controlling method as claimed in claim 15, wherein the obtaining the interpolated frame comprises:
based on the first frame rate being a frame lower than the second frame rate and a plurality of common key frames not including a key frame corresponding to at least one interpolation time point of the second image area, obtaining interpolated frames corresponding to the at least one interpolation time point by adjusting the interpolation time points between a first input time point of a first command key frame and a second input time point of a second command key frame.

17. The controlling method as claimed in claim 16, the controlling method further comprises:
identifying and storing an interpolation time point, an interpolation cycle and a key frame input time point according to a combination of original frame rates of the respective image areas in the memory;
wherein the obtaining the interpolated frame comprises:
based on the original frame rates of the respective image areas of the input image being identified, identifying the interpolation time point, the interpolation cycle, and the key frame input time point corresponding to the original frame rates of the respective image areas based on information stored in the memory; and
obtaining interpolated frames for the respective image areas based on the identified interpolation time point, the identified interpolation cycle, and the identified key frame input time.

18. The controlling method as claimed in claim 11, the controlling method further comprises:
identifying Sum of Absolute Difference (SAD) values for the respective image areas identified for consecutive frames of the input image; and
identifying the original frame rates of the respective image areas by identifying SAD patterns for the respective image areas according to a case in which a SAD value of a previous frame and a current frame is less than a threshold value and a case in which the SAD value is equal to or greater than the threshold value.

19. The controlling method as claimed in claim 18, the controlling method further comprises:
based on the original frame rates of the respective image areas being identified based on the SAD patterns for the respective image areas, adjusting the original frame rates of the respective image areas based on a difference in an original frame rate between a specific image area and adjacent image areas.

20. A non-transitory computer-readable recording medium storing a computer instruction that, when executed by a processor of an electronic device, causes the electronic device to:
based on original frame rates of respective image areas of an input image being identified, identify interpolation time points for the respective image areas and a plurality of key frames based on the original frame rates of the respective image areas;
obtain interpolated frames corresponding to the interpolation time points for the respective image areas based on the plurality of key frames; and
display an output image based on the obtained interpolated frames.
